(19) United States
(12) Patent Application Publication
(10) Pub. No.: US 2008/0177675 A1
(43) Pub. Date: Jul. 24, 2008

(54) Commodity-Based Index and Investment and Financial Risk Management Products

(75) Inventor: Jonathan Arginteanu, Nyack, NY (US)

Correspondence Address: FISH & RICHARDSON P.C., P.O. BOX 1022, MINNEAPOLIS, MN, 55440-1022, US

(73) Assignee: NEW YORK MERCANTILE EXCHANGE, INC., New York, NY (US)

(21) Appl. No.: 11/955,071

(22) Filed: Dec. 12, 2007

Related U.S. Application Data
(60) Provisional application No. 60/869,787, filed on Dec. 13, 2006.

(51) Int. Cl. G06Q 40/00; G06F 17/00

(52) U.S. Cl. 705/36 R

(57) ABSTRACT

Investment and financial risk management products and methods are provided that are based on a commodity index. The commodity index has a numerical value that, based on an algorithm, tracks the settlement prices of a predetermined group of commodities on a futures exchange. Based on this index, a futures contract is offered on the futures exchange. Moreover, an exchange-traded fund, options on the exchange-traded fund, and options on the futures contract are also provided.

### CLAIM OF PRIORITY

This application claims priority under 35 USC §119(e) to U.S. Provisional Patent Application Ser. No. 60/869,787, filed on Dec. 13, 2006, the entire contents of which are hereby incorporated by reference.

### TECHNICAL FIELD

This disclosure relates to a commodity-based index and investment and financial risk management products.

### BACKGROUND

Years ago, exchange trading largely resembled a marketplace. Merchants offering commodities for sale brought samples to the exchange, and buyers would come to the exchange to examine the quality of the offered merchandise. If the quality was found to be acceptable, buyers would bid on the merchandise. Sellers and buyers vied against each other to obtain the best price for their products or to buy at the most competitive price, respectively. Today, however, physical supplies of the traded commodities are nowhere to be found in the offices of the world's leading commodity exchanges, e.g., the New York Mercantile Exchange, Inc. (NYMEX). In reality, goods are infrequently delivered through exchanges at all, even though some exchange rules permit it. Instead, traders buy and sell on the exchange through instruments called futures contracts.

Generally speaking, a futures contract is an agreement to purchase or sell a commodity for delivery in the future (1) at a price that is determined at initiation of the contract; (2) that obligates each party to the contract to fulfill the contract at the specified price; (3) that is used to assume or shift price risk; and (4) that may be satisfied by delivery or offset. Futures contracts are most often liquidated prior to the delivery date and are generally used as a financial risk management tool rather than for supply purposes. These contracts are traded on regulated exchanges and are settled daily based on their current value in the marketplace. A contract's final settlement (i.e., settlement after expiration of the futures contract) can be the cash settlement type, or the delivery settlement type. But, even in the case of delivery-settlement type futures contracts, very few actually result in delivery. The settlement price is an amount that an exchange treats as a value, usually established by an exchange settlement committee at the close of each trading session for each futures contract for each commodity for delivery at a particular time in the future, used by the clearinghouse in determining net gains or losses, margin requirements, and the next day's price limits. The close in futures trading refers to a brief period at the end of the day, during which transactions frequently take place quickly and at a range of prices immediately before the closing bell. Although the term “settlement price” is used as an approximate equivalent to the term “closing price,” a settlement price is not any particular transaction price (i.e., the price of a particular trade). In contract months with significant trading volume in the closing range, the settlement price can be derived by calculating the weighted average of the prices at which trades were conducted during the closing range. For months that have little to no volume during the closing range, trade data can be used together with other factors the exchange believes should be taken into account.

Futures contracts are standardized to make sure that the prices mean the same thing to everyone in the market; everyone trades contracts with the same specifications for quality, quantity, and delivery terms. An advantage of standardization is that it reduces the number of variables that need to be negotiated before a trade can be executed. The specifications generally would include: (1) the underlying asset: this can be anything from a barrel of light, sweet crude oil to a short term interest rate to pork bellies; (2) the type of final settlement: either cash settlement or physical settlement (following the final termination of trading on the last day of a listed contract month) and if physically delivered the nature of the delivery procedures; (3) the amount and units of the underlying asset per contract: this can be the notional amount of bonds, a fixed number of barrels of oil, units of foreign currency, the notional amount of the deposit over which the short term interest rate is traded; (4) the currency in which the futures contract is quoted; (5) the grade and quality specifications of the deliverable assets: in the case of bonds, this specifies which bonds can be delivered; in the case of physical commodities, this specifies not only the quality of the underlying goods but also the manner and location of delivery (e.g., the NYMEX Light Sweet Crude Oil contract specifies the acceptable sulfur content and API specific gravity, as well as the location where delivery must be made); (6) the delivery month; (7) the last trading date; and (8) other details such as the commodity trading tick size.

Traders can seek exposure to a given market or sector through the purchase of an index-based investment product. Such products are based on an index that utilizes an algorithm to track a certain market (e.g., the NASDAQ Composite® index) or sector (e.g., the NASDAQ-100® technology index). One manner of achieving returns with an index product is by arbitrage. In short, a trader takes a buy or sell position in the index product and the opposite position in the index product's constituents. By taking advantage of market inefficiencies, arbitrage can achieve substantial returns.

The discussion of the background is included to explain the context of certain implementations. This is not to be taken as an admission that any of the material referred to was published, known, or part of the common general knowledge as at the priority date of any of the claims.

Throughout the description and claims of the specification the word “comprise” and variations thereof, such as “comprising” and “comprises”, is not intended to exclude other additives, components, integers or steps.

### SUMMARY

In one aspect, investment products and methods are provided that are based on a commodity index. The commodity index has a numerical value that, based on an algorithm, tracks the settlement prices of a predetermined group of commodities on a futures exchange. Based on this index, a futures contract is offered on the futures exchange. Moreover, an exchange-traded fund, options on the exchange-traded fund, and options on the futures contract are also provided.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a commodity index.

FIG. 2 is a flow chart of an implementation for deriving the commodity index value and commodity index futures contract value.

FIG. 3 is a flow chart of an implementation of algorithms for deriving the commodity index value and commodity index futures contract value.

FIG. 4 is a chart depicting an exemplary application of an algorithm.

FIG. 5 is a flow chart of an implementation of a method for offering products based on a commodity index.

FIG. 6 is a flow chart depicting exemplary methods of arbitrage.

### DETAILED DESCRIPTION

The following is a description of preferred implementations, as well as some alternative implementations, of investment products and methods are that are based on a commodity index.

In some implementations, an index is created that represents the value of a preselected group of commodities futures contracts. Preferably, the group consists of fewer than 10 commodities, and more preferably, 5 or fewer commodities. It is also preferred that all of the commodities trade on a single futures exchange, e.g., the NYMEX. Several products are then provided based on the index. A futures contract (and related options contract) based on the index is provided by the futures exchange. Moreover, a commodity pool, in communication with the futures exchange, can offer an exchange-traded fund (ETF) on a stock exchange based on the index. Options on the exchange-traded fund can be traded on a futures exchange. The advantage of this product and related methods is that it allows a trader to effectively arbitrage in the futures market with an index product. This advantage is discussed in more detail herein.

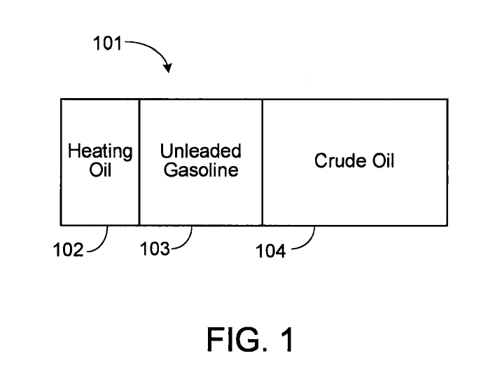

FIG. 1 schematically represents an exemplary composition of an index 101, and therefore, the composition of a futures contract based on the index. As shown in this example, the index is based on the energy sector, and comprises heating oil 102, unleaded gasoline 103 and crude oil 104. In this example, the components 102, 103 and 104 are provided in the ratios of 1:2:3. This ratio can vary in other implementations (e.g., 1:1:1, 2:1:1, 4:1:3, 3:3:1 and other permutations thereof). In this implementation, the settlement price of crude oil 104 affects the numerical value of index 101 three times as much as heating oil 102 does, and the settlement price of unleaded gasoline 103 affects the numerical value of index 101 two times as much as heating oil 102 does.

In this implementation, 1:2:3 was chosen to broadly represent values of energy traded in the United States (and worldwide). This implementation utilizes a mathematically simple ratio because, among other things, it facilities arbitrage (discussed in more detail herein).

Heating oil 102 can represent the benchmark futures contract traded under the symbol HO on the NYMEX. Heating oil, also known as No. 2 fuel oil, accounts for about 25% of the yield of a barrel of crude, the second largest portion after gasoline. The heating oil futures contract HO trades in units of 1000 barrels (i.e., 42,000 gallons) and is based on delivery in New York harbor, a principal cash market trading center. The heating oil futures contract is commonly used to hedge heating oil itself, as well as diesel fuel and jet fuel, both of which trade in the cash market at an often stable commercial price relationship to heating oil futures.

Unleaded gasoline 103 can represent the benchmark futures contract traded under the symbol RB on the New York Mercantile Exchange. Gasoline is the largest single volume refined product sold in the United States and accounts for almost half of national oil consumption. It is a highly diverse market, with hundreds of wholesale distributors and thousands of retail outlets, making it subject to intense competition and price volatility. The RB futures contract trades in units of 1000 barrels (i.e., 42,000 gallons). It is based on delivery at petroleum products terminals in the New York harbor, the major East Coast trading center for imports and domestic shipments from refineries in the New York harbor area, Europe and from the Gulf Coast refining centers. The underlying gasoline currently conforms to industry standards for reformulated regular gasoline blendstock for blending with 10% denatured fuel ethanol (92% purity) as listed by the Colonial Pipeline for fungible F grade for sales in New York and New Jersey. RB is a wholesale non-oxygentated blendstock traded in the New York Harbor barge market that is ready for the addition of 10% ethanol at the truck rack.

Crude oil 104 can represent the benchmark futures contract traded under the symbol CL on the New York Mercantile Exchange. Crude oil is the world's most actively traded commodity, and the light, sweet crude oil futures contract (CL) at NYMEX is at present the world's most liquid forum for crude oil trading, as well as the world's largest-volume futures contract trading on a physical commodity. The contract trades in units of 1000 barrels (i.e., 42,000 gallons), and the delivery point is Cushing, Okla., which is also accessible to the international spot markets via pipelines. The contract provides for delivery of several grades of domestic and internationally traded foreign crudes (with the foreign crudes being delivered at a discount or premium to the final settlement price), and serves the diverse needs of the physical market. Light, sweet crudes are preferred by refiners because of their low sulfur content and relatively high yields of high-value products such as gasoline, diesel fuel, heating oil and jet fuel.

In other implementations, other commodities can be included in the index 101. For example, natural gas could be added, resulting in a ratio of 1:1:2:3. Natural gas can represent the benchmark futures contract traded under the symbol NG on the New York Mercantile Exchange. Natural gas accounts for almost a quarter of United States energy consumption. The NG futures contract trades in units of 10,000 million British thermal units (mmBtu). The price is based on delivery at the Henry Hub in Louisiana, the nexus of 16 intra- and interstate natural gas pipeline systems that draw supplies from the region's prolific gas deposits. The pipelines serve markets throughout the U.S. East Coast, the Gulf Coast, the Midwest, and up to the Canadian border.

Moreover, other implementations of the index can focus on other sectors. Preferably, however, the index is based on the constituents of a spread, e.g., a crack spread or a calendar spread.

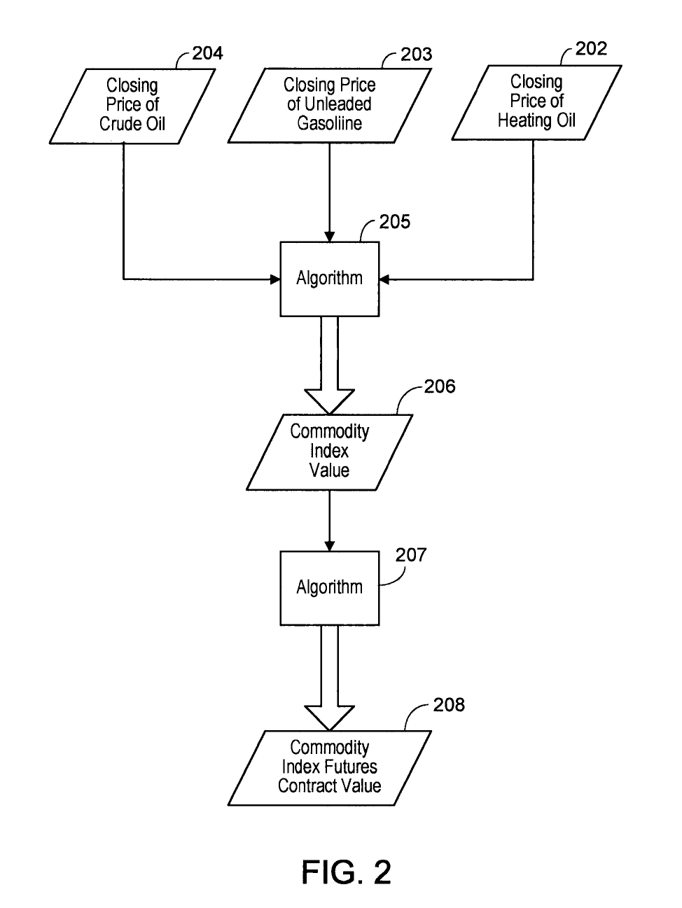

FIG. 2 depicts an implementation of the overall methodology for arriving at the numerical value of the commodity index and the commodity index futures contract. The methodology utilizes the settlement prices of crude oil 204, unleaded gasoline 203 and heating oil 202. The manner for traders to assess the market value of a futures contract during a trading session varies depending upon the nature of the commodity. When the deliverable asset exists in plentiful supply, or may be freely created, then the price of a futures contract is generally determined by arbitrage analysis. Under arbitrage analysis, the futures price represents the expected future value of the underlying asset discounted at the risk free rate. Thus, for a simple, non-dividend paying asset, the value of the future, F(t), will be found by discounting the present value S(t) at time t to maturity T by the rate of risk-free return r:

F(t)=S(t)*(1+r)^{(T-1)},

or, with continuous compounding

F(t)=S(t)e^{r(T-t)}

This relationship may be modified for storage costs, dividends, dividend yields, and convenience yields. In a perfect market, the relationship between futures and spot prices depends only on the above variables; in practice, however, there are various market imperfections (transaction costs, differential borrowing and lending rates, restrictions on short selling) that disrupt this relationship. Thus, the futures price in fact varies within arbitrage boundaries around the theoretical price. This relationship, however, is typical for stock index futures, treasury bond futures and futures on physical commodities when they are in supply (e.g., corn after the harvest).

However, for many commodities, a host of unpredictable factors affect futures pricing, and as such, the futures price cannot be fixed by arbitrage. This is generally the case with, e.g., crude oil, unleaded gasoline, heating oil and natural gas. For these futures contracts, settlement prices are generally created by a panel after a day of open-outcry trading.

At the NYMEX, a panel known as the Settlement Price Committee (SPC) is used to create settlement prices. The SPC does not merely assist in determining the settlement price for each futures contract, but rather determines the settlement price, pursuant to the NYMEX's rules, through a process that reflects the exercise of judgment and discretion.

The SPC subcommittee for each type of commodity meets to determine the settlement price soon after the close of trading in the energy futures contract, which currently occurs at 2:30 p.m. Eastern time.

NYMEX Exchange Rule 6.52 governs the creation of crude oil, heating oil, and gasoline contracts settlement prices, while Rule 6.52A similarly governs settlement prices for natural gas contracts. These rules provide for the use of a weighted average price for certain contract months based upon specific criteria and additionally provide for the use of spread values in determining other contract months. The panel has the ability to exercise its judgment and discretion in its creation of settlement prices. Moreover, certain NYMEX rules allow an individual NYMEX staff member on a subcommittee to maintains veto authority in the final determination of settlement prices.

Regardless of the manner of determining the futures contract pricing, the settlement prices are provided to an algorithm 205. The algorithm 205 performs several calculations that weigh the settlement prices 202, 203 and 204 of the constituent commodities. Algorithm 205 generates the commodity index value 206. In this implementation, the commodity index value 206 is processed by an algorithm 207 to yield the price of an futures contract 208 based on the index value 206. The algorithm 207 applies a multiplier (or divisor) to the commodity index value 206 to yield a futures contract value 208 that is conveniently traded on a futures exchange. The commodity index value 206 is the basis for several investment and financial risk management products, including an investment product traded on a stock exchange.

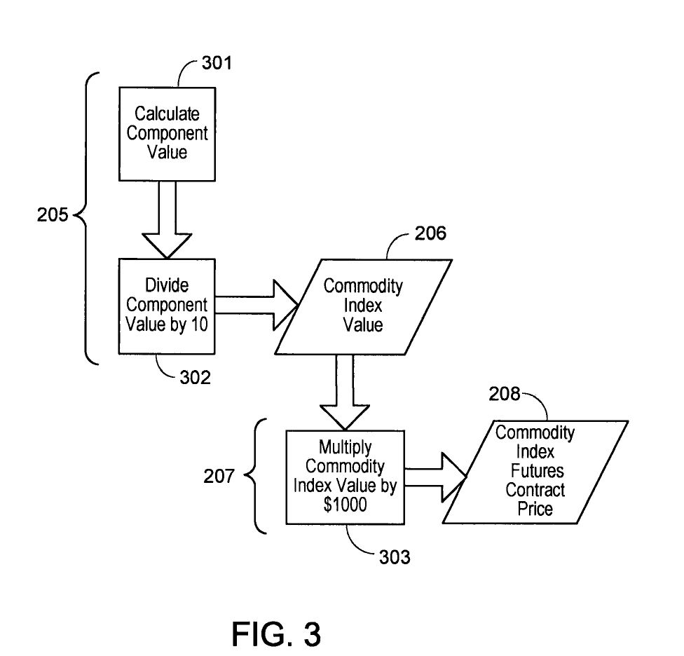

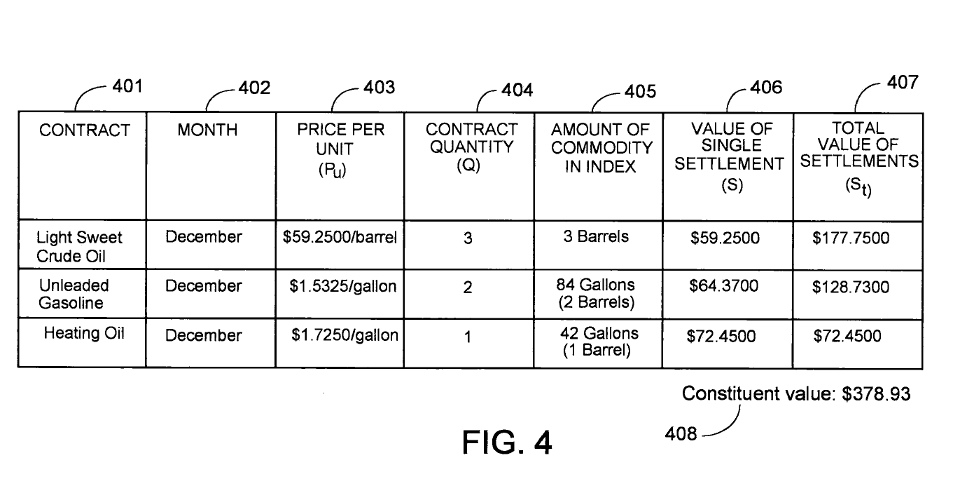

FIG. 3 depicts an implementation of algorithms 205 and 207 of FIG. 2. In this implementation, algorithm 205 is divided into two major processes: calculation of the component value 301 and division of the component value by ten 302. The component value represents a weighted total of the value of the constituent commodities. This process is discussed in detail with reference to FIG. 4. In this implementation, the commodity index value 206 is the component value (calculated by process 301) divided by 10 (process 302).

As implemented here, the algorithm 207 for deriving the commodity index futures contract price 208 includes multiplying the commodity index value 206 by $1000 (by process 303). In other implementations, algorithm 207 can multiply the commodity index value 206 by a monetary factor other than $1000, depending on, e.g., the constituent commodities and the desired purchasers. For example, a financial risk management product geared toward individual traders can utilize a monetary factor lower than $1000 (e.g., $10), whereas a product geared toward large institutional traders can use a larger monetary factor (e.g., $25,000). Moreover, additional steps can be added to algorithm 207, including the addition of an up-front purchase fee (e.g., a load, management fee or a convenience fee).

Note that the pricing of the commodity index futures contract does not itself necessarily conform to the models discussed above. Instead, its price is calculated by one or more algorithms. The constituent commodities, however, may be priced in accordance with an arbitrage and/or supply/demand model. Accordingly, the commodity index futures price 208 (and commodity index value 206) can be quickly and easily determined once the settlement prices of the constituents are determined. Algorithms 205 and 207 are preferably executed by one or more programmed computers to achieve quick and convenient calculation of the commodity index value 206 and commodity index futures contract price 208. The commodity index value 206 and commodity index futures contract price 208 are preferably determined at least each day that the futures exchange is open for trading. More preferably, 206 and 208 are determined each day soon after close of trading, thereby allowing daily settlement of the commodity index futures contract.

FIG. 4 is a table that depicts an implementation of a method for calculating of the component value 301 in greater detail. Note that this example uses exemplary settlement prices 406 for the purpose of illustration. Actual implementations utilize daily settlement prices.

Each futures contract is identified by the underlying asset 401 (here, crude oil, unleaded gasoline, and heating oil) and the contract month 402 (here, all are December contracts). Each contract for the underlying assets 401 has a price 403 associated with a particular amount of the underlying asset. In this example, light sweet crude oil is priced at $59.2500 per barrel, unleaded gasoline is priced at $1.5325 per gallon and heating oil is priced at $1.7250 per gallon. While each contract 401 is normally sold on the open market in particular increments of the underlying asset (usually 1000 barrels, i.e., 42,000 gallons), for purposes of calculating the index value, the pricing model is based on the settlement price of a single barrel (i.e., 42 gallons). This modified increment is referred to as the index contract increment.

Field 404 identifies, on a relative basis, how much of each contract (CL, RB and HO) is represented by the commodity index value. In this implementation, there are 3 crude oil contracts to 2 unleaded gasoline contracts to 1 heating oil contract. This, in combination with the index contract increments, yields the relative amount of each commodity in the index 405. Accordingly, there are 3 barrels of crude oil to every 84 gallons (2 barrels) of unleaded gasoline to every 42 gallons (1 barrel) of heating oil.

Each contract (CL, RB and HO) has a settlement price 406. The settlement price 406 represents the price (403) multiplied by the index contract increment. In this implementation, the settlement prices (rounded to two decimals) of individual contracts are calculated as follows:

| | Price per unit | Index Contract | Settlement Price |
|---|---|---|---|
| Contract | (Pᵤ) | Increment (ICI) | (Pᵤ * ICI) |
| Crude Oil | $59.25000/barrel | 1 barrel | $59.2500 |
| Unleaded | $1.5325/gallon | 42 gallons | $64.3700 |
| Gasoline | | (1 barrel) | |
| Heating Oil | $1.7250/gallon | 42 gallons | $72.4500 |
| | | (1 barrel) | |

The value of each single settlement 406 is multiplied by the contract quantity 404 to yield the total value of settlements for each contract 407. Where Sₜ represents the total value of settlements for each contract 407, Q represents the contract quantity 404 and S represents the price of a single settlement 403, a formula for calculating Sₜ is as follows:

Sₜ=Q*S

The component value 408 (i.e., the value calculated at step 301 in FIG. 3) is calculated by totaling the total value of settlements for each contract. A formula for calculating the component value, CV, is as follows:

CV=S_{t(CL)}+S_{t(RB)}+S_{t(HO)}

Using these exemplary settlement prices 406, the constituent value 408 would be $378.93. Turing back to implementation described in FIG. 3, upon dividing the component value by 10 (step 302), a commodity index value of 37.8930 is obtained. This value multiplied by $1000 (step 303) results in the commodity index futures contract price (208) of $37,893. In this implementation, a trader who holds ten commodity index futures contracts versus three crude oil contracts, two unleaded gasoline contracts and one heating oil contract will have a financially square position or a neutral position from a risk perspective. Put another way, purchase commitments are offset by sell commitments.

It is preferred that the component value 408, commodity index value 206, and commodity index futures contract price 208 be recalculated at least on a daily basis after the settlement prices 406 have been determined. It is also preferred that the minimum tick of the commodity index futures contract price be $10, although other ticks are possible, such as $5, $50, or $100.

Note, of course, that all formulae may vary to account for the addition of other commodity contracts into the index.

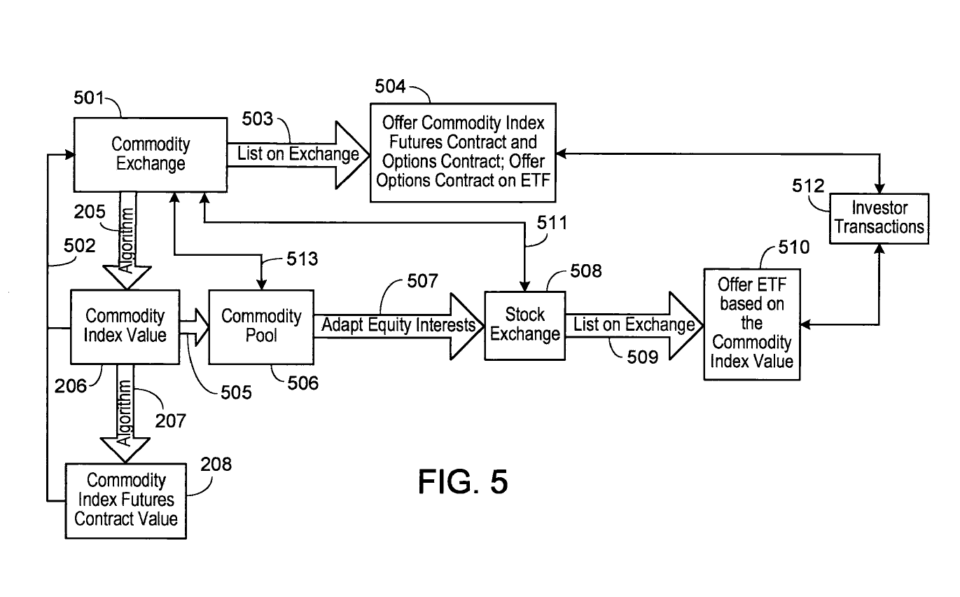

FIG. 5 illustrates an implementation of a method for offering products based on a commodity index. As discussed, a futures exchange 501 (e.g., the New York Mercantile Exchange) utilizes an algorithm 205 to calculated a commodity index value 206 based on the settlement prices of a preselected group of commodities. It is preferred that all of the commodities in the preselected group are listed on the futures exchange 501 (as opposed to being split across several futures exchanges). Another algorithm 207 is applied to the commodity index value 206 to yield the commodity index futures contract value 208. Values 206 and 208 are generated and communicated 502 within the futures exchange for purposes such as initially listing the commodity index futures contract, publishing updated settlement prices of the commodity index futures contract 208 and publishing updated commodity index values 206. Communication 502 can be implemented by way of a computer network within the futures exchange 501, via the internet or the values 206 and 208 could be manually communicated as needed.

Before any products relating to the commodity index can be offered for sale to the public, they must first be listed on the futures exchange 503. For implementations subject to United States regulatory agencies, step 503 can include receiving approval from the Commodity Futures Trading Commission (CFTC) should a futures exchange voluntarily determine to seek prior approval rather than utilize the other rule submission approach noted below. The CFTC reviews the terms and conditions of proposed contracts (such as the commodity index futures contract), and oversees registration of firms and individuals who either handle customer funds, give trading advice or who engage in direct trading on the floor of a futures exchange. The Commodity Futures Modernization Act of 2000 gave exchanges the flexibility to “self certify” new futures contracts, options contracts on futures contracts and new rules and rules amendments without prior CFTC approval, although the contracts or rules as applicable must still be submitted to the CFTC before they are launched, and the CFTC has final oversight. Moreover, step 503 can include steps that are taken to maintain listings, e.g., continuing regulatory compliance.

Once the products have been (and continue to be) listed 503, the exchange 501 may offer products (step 504) to the public based on the commodity index value 206. These products are based on the commodity index value 206 and include a cash-settled futures contract (priced as per item 208) and an options contract on the futures contract.

There are two types of options contracts that can be offered: “calls” and “puts.” A call gives the holder of the options contract the right, but not the obligation to buy the underlying commodity index futures contract. Conversely, a put gives the holder the right but not the obligation to sell the underlying commodity index futures contract. The price at which the underlying commodity index futures contract may be bought or sold is the exercise price, also called the strike price. An options contract affords the right to buy or sell for only a limited period of time; each options contract has an expiration date. On the opposite side, a seller, or writer of an options contract incurs an obligation to perform, should an options contract be exercised by the purchaser. The writer of a call incurs an obligation to sell the commodity index futures contract and the writer of a put has an obligation to buy the commodity index futures contract.

In return for the rights granted, an options buyers pays an options seller a premium. Generally, there are four major factors affecting the price of the options contract: (1) the price of the commodity index futures contract relative to the options strike price; (2) time remaining before options expiration; (3) volatility of underlying commodity index futures price and (4) interest rates.

The options contract is a wasting asset. It has an initial value that declines, or wastes away, as time passes. Depending upon the movement of the options price, the options buyer will choose one of three alternatives for terminating an options position: (1) exercise the options contract; (2) liquidate it by selling it back on the futures exchange or (3) let it expire. While liquidation is the most common choice, a small percentage of buyers choose to exercise their options, particularly if their strategy calls for acquiring a long or short futures position at the strike price. If the commodity index futures price does not move far enough for an exercise to be worthwhile, or moves in the opposite direction, buyers can simply let their options contract expire valueless. As in the futures market, options trading takes place in a primarily open outcry auction market on the futures exchange 501.

Also, the futures exchange 501 can offer an options contract on an exchange-traded fund (ETF) listed on a stock exchange 508. The foregoing discussion of options contracts on the commodity index futures contract applies to this discussion as well. The value of the ETF is based on the commodity index value 206. In this implementation, a commodity pool 506 is established with a pool operator. For implementations subject to United States regulatory agencies, the pool operator can be a commodity pool operator (CPO) registered under the Commodity Exchange Act. The commodity pool 506 can be organized as a limited liability entity such as an LLC. In order to track the performance of the commodity index value 206, the commodity pool 506 invests (via communications 513 with the futures exchange 501) solely in the commodities future contracts that make up the commodity index (i.e., constituents 102, 103 and 104 of FIG. 1) in the proportion that they are represented in the index 101. To monitor tracking error, the commodity pool 506 receives via a communication 505 (e.g., a network communication via the internet or a VPN) the commodity index value 206 on a periodic basis.

To make the ETF available for purchase on the public stock exchange 508, equity interests in the commodity pool 506 must be adapted via step 507 for public trading on the stock exchange 508. In implementations subject to United States regulations, equity interests in commodity pool 506 can be registered under the Securities Act of 1933 via Form S-1. Upon completing regulatory requirements, the ETF shares (i.e., individual equity interests in the commodity pool 506) are listed on the stock exchange 509 and offered publicly to traders 510. The price of the ETF shares can be priced intraday, providing price transparency to traders and the market In some implementations, a fee may be built into the price of the ETF share. The target market for the ETF is more likely to be individual traders rather than institutional traders.

To enable a futures exchange 501 to offer an options contract on the ETF, it should periodically be in communication with data from the stock exchange 508 regarding the ETF. Note that since commodity futures and stock options are not often listed on the same futures exchange, futures exchange 501 may refer to one or more separate futures exchanges.

This implementation allows trader transactions 512 to occur, including the purchase, sale, and taking of positions in (1) commodity index futures contracts (and options thereon) and (2) exchange-traded funds based on the commodity index (and options thereon).

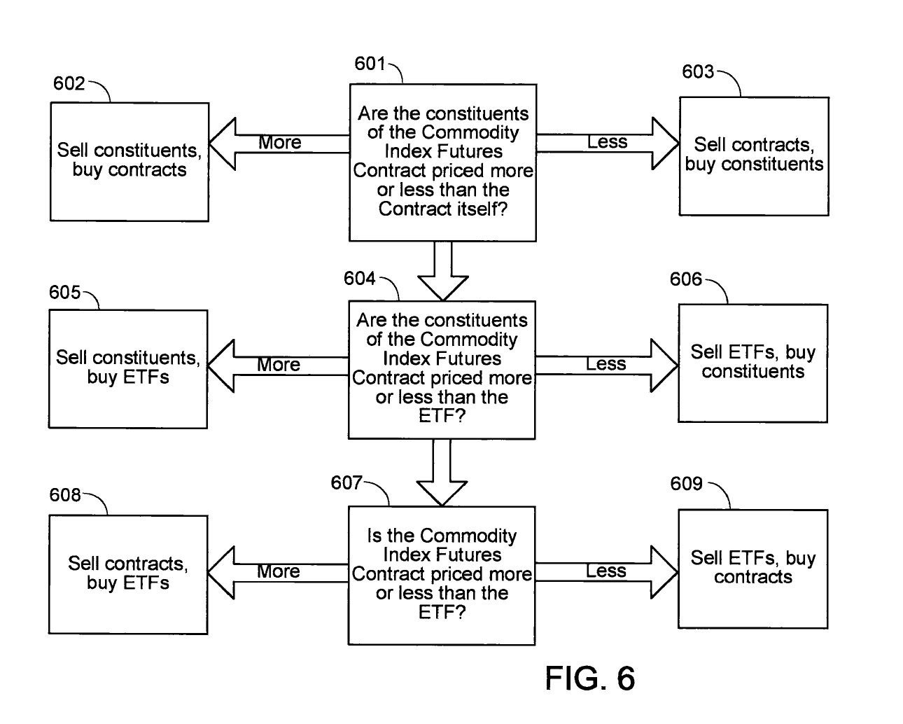

FIG. 6 depicts a methodology for realizing an advantage of products that are associated with a commodity index. Many commodities do not trade today at their future price discounted at the risk-free interest rate (see discussion above regarding pricing of futures contracts). Examples of such commodities are those that make up the index 101 of FIG. 1 (heating oil, unleaded gasoline and crude oil). This creates an opportunity for profit by way of arbitrage. Put simply, arbitrage is the practice of taking advantage of a state of imbalance between two or more markets. A combination of matching deals are struck that capitalize upon the imbalance, the profit being the difference between the market prices.

One example of arbitrage involves a stock on a stock exchange and its option on a futures exchange. When the price of a stock on the stock exchange and its corresponding futures contract on the options exchange are out of balance, one can buy the less expensive one and sell the more expensive. Because the differences between the prices are likely to be small (and not last very long), this can only be done profitably with computers examining a large number of prices and automatically exercising a trade when the prices are far enough out of balance. Those with the fastest computers and the smartest mathematicians can take advantage of series of small differentials that would not be profitable if taken individually.

Existing methods of arbitrage between a commodities-based index and its underlying components are even more difficult. For example, traders can purchase futures contracts or over-the-counter (OTC) derivatives based on Goldman Sachs's Commodity Index (GSCI®). The GSCI® represents the performance of about 25 commodities from all commodity sectors—it aims to provide commodity diversification.

The constituent commodities are spread across several commodity exchanges, and not all may lend themselves to arbitrage. Therefore, for a trader to arbitrage in the commodities market, he would purchase (or sell) a position in the GSCI®, and proceed to individually sell (or purchase) its constituents across all of the several commodities markets. Such a trader would likely lose opportunity for profit due to, e.g., (1) the transaction costs and time associated with purchasing and selling an array of constituents across an array of commodity exchanges and (2) the difficulty of identifying which of the constituents would best lend themselves to arbitrage (i.e., the same problem associated with stock/option arbitrage, discussed above). Alternatively, a trader could purchase an OTC derivative of the GSCI®. However, there are substantial disadvantages to such OTC transactions, including lack of market protection, no transaction guarantees, no clearinghouse and no transparency.

The products associated with the index 101 of FIG. 1 overcome these problems. Because the index 101 consists of comparatively small number of commodities traded preferably on a single futures exchange, the transaction time and costs are substantially reduced. Moreover, because the constituents of the index 101 represent both the source materials (crude oil) and resulting products (heating oil and unleaded gasoline) of a commercial process, they lend themselves to profitable arbitrage. FIG. 6 depicts an implementation of a method for arbitraging with products based on the commodity index 101 of FIG. 1. This process can be automated by a programmed computer configured to automatically execute appropriate trades.

It is presumed in this implementation that the trader owns two varieties of products associated with the commodity index (ETFs and futures contracts), as well as the constituents of the commodity index (e.g., 102, 103 and 104 of FIG. 1). Steps 601, 604 and 607 need not be performed in sequential order; in fact, they may be performed simultaneously. Moreover, the inquiries as to whether one investment or financial risk management product is priced “higher” than another does not necessarily refer to comparing the price of, e.g., one commodity index futures contract to one ETF share, or the total of the constituents compared to one ETF share. Instead, the comparison can focus on the relative value of the investments, e.g., in this implementation, comparing the price of ten commodity index futures contracts to the total price of 3 crude oil futures contracts (CL), 2 unleaded gasoline futures contracts (RB) and 1 heating oil contract (HO).

It is determined at step 601 whether the constituents of the commodity index futures contract are priced more or less than the contract itself. If the constituents are priced higher than the contract, the trader takes a sell position in the constituents, and a buy position in the contract (step 602). If the contract is priced higher than the constituents, the trader takes a sell position in the contract, and a buy position in the constituents (step 603). Note that the trader may arbitrage by buying and selling in any proportion, and is not required to maintain a square position. In other words, a trader is not limited to buying ten 10 contracts and selling 3 crude oil contracts, 2 unleaded gasoline contracts and 1 heating oil contract. Instead, a trader can take advantage of, e.g., pronounced discrepancies in crude oil pricing by either buying or selling a greater proportion of crude oil futures contracts.

It is determined at step 604 whether the constituents of the commodity index futures contract are priced more or less than the ETF. If the constituents are priced higher than the ETF, the trader takes a sell position in the constituents, and a buy position in the ETF (step 605). If the ETF is priced higher than the constituents, the trader takes a sell position in the ETF, and a buy position in the constituents (step 606). The ETF, because it is priced intra-day and may suffer from positive or negative tracking error, offers additional opportunities for arbitrage.

At step 607, it is determined whether the commodity index futures contract is priced more or less than the ETF. If the commodity index futures contract is priced higher than the ETF, the trader takes a sell position in the contract, and a buy position in the ETF (step 608). If the ETF is priced higher than the contract, the trader takes a sell position in the ETF, and a buy position in the contract (step 609). Again, because the ETF it is priced intra-day and may suffer from tracking error, it offers additional opportunities for arbitrage.

The components described above may be implemented as one or more computer software/logic programs/modules stored in a memory or computer storage device and executable by a computer processor to implement the disclosed functionality and process. It will be appreciated that the components described above may include a computer system and network. Such a computer system should include a Pentium-class processor, or suitable equivalent, a hard disk drive with sufficient capacity, a memory with sufficient capacity, and a suitable output device such as a flat panel LCD display. Further the computer should execute an appropriate operating system, such as Microsoft Windows XP, published by the Microsoft Corporation, located in Redmond, Wash. The computer system may include a network interface being of a suitable type for the network, such as an Ethernet or optical based network. The network may be a public or private network, such as the Internet, an intranet, a virtual private network, or other TCP/IP or non TCP/IP based network, as is known in the art. Further, secure protocols, such as sHTTP or encryption, may be included to protect communication from being intercepted or modified and to generally authenticate users and ensure secure operation.

It will be appreciated that any suitable computer system having suitable processing, storage and communications capability may be used with the disclosed implementations, such as a mainframe computer, mini-computer, a workstation, a personal computer or a personal digital assistant. It will be further appreciated that the disclosed implementations may be executed on a single computer system or one or more components may be executed on a computer system which is separate from one or more computer systems executing the remaining components, and suitably interconnected, such as via a network.

A number of implementations have been described. Nevertheless, it will be understood that various modifications may be made without departing from the spirit and scope of the invention. For example, the commodity index may be based on commodities from any sector. Accordingly, other implementations are within the scope of the following claims.

What is claimed is:

1. A method for providing an investment or financial risk management product comprising:
identifying a group of five or fewer commodities traded on a futures exchange;
determining the settlement prices of each of the commodities;
assigning a weighting factor for each of the commodities;
calculating a component value based on the total of the settlement price of each commodity multiplied by its respective weighting factor;
calculating an index value by applying an algorithm to the component value; and
offering a futures contact, traded on the futures exchange, based on the index value.

2. The method of claim 1 wherein the group of five or fewer commodities consists essentially of crude oil, gasoline and heating oil.

3. The method of claim 1 wherein the group of five or fewer commodities consists essentially of crude oil, gasoline, heating oil and natural gas.

4. The method of claim 1 wherein the group of five or fewer commodities are all traded on the same futures exchange.

5. The method of claim 2 wherein assigning a weighting factor comprises:
assigning a weighting factor of three to crude oil;
assigning a weighting factor of two to unleaded gasoline; and
assigning a weighting factor of one to heating oil.

6. The method of claim 3 wherein assigning a weighting factor comprises:
assigning a weighting factor of three to crude oil;
assigning a weighting factor of two to unleaded gasoline;
assigning a weighting factor of one to heating oil; and
assigning a weighting factor of one to natural gas.

7. The method of claim 1 further comprising:
offering an options contract, traded on a futures exchange, based on the futures contract.

8. A method for providing an investment or financial risk management product comprising:
receiving a commodity index value from a futures exchange, the commodity index value relating to the settlement prices of a preselected group of five or fewer commodities traded on the futures exchange, wherein each of the settlement prices are multiplied by a weighting factor;
purchasing each commodity in a proportion substantially consistent with its weighting factor;
offering an exchange-traded fund, on a stock exchange, whose value substantially tracks the commodity index value.

9. The method of claim 8 wherein the group of five or fewer commodities consists essentially of crude oil, gasoline and heating oil.

10. The method of claim 8 wherein the group of five or fewer commodities consists essentially of crude oil, gasoline, heating oil and natural gas.

11. The method of claim 9 wherein the weighting factor for crude oil is three, the weighting factor for unleaded gasoline is two and the weighting factor for heating oil is one.

12. The method of claim 10 wherein the weighting factor for crude oil is three, the weighting factor for unleaded gasoline is two, the weighting factor for heating oil is one and the weighting factor for natural gas is one.

13. The method of claim 8 further comprising:
providing an options contract, traded on a futures exchange, based on the exchange-traded fund.

14. An article comprising a machine-readable medium that stores machine-executable instructions for causing a machine to:
receive the identity of a group of five or fewer commodities traded on a futures exchange;
determine the settlement prices of each of the commodities;
receive a weighting factor for each of the commodities;
calculate a component value based on the total of the settlement price of each commodity multiplied by its respective weighting factor;
calculate an index value by applying an algorithm to the component value; and
calculate the price of a futures contact, traded on the futures exchange, based on the index value.

15. The article of claim 14 wherein the group of five or fewer commodities consists essentially of crude oil, gasoline and heating oil.

16. The article of claim 14 wherein the group of five or fewer commodities consists essentially of crude oil, gasoline, heating oil and natural gas.

17. The article of claim 14 wherein the group of five or fewer commodities are all traded on the same futures exchange.

18. The article of claim 15 wherein the weighting factor for crude oil is three, the weighting factor for unleaded gasoline is two and the weighting factor for heating oil is one.

19. The article of claim 16 wherein the weighting factor for crude oil is three, the weighting factor for unleaded gasoline is two, the weighting factor for heating oil is one and the weighting factor for natural gas is one.

20. The article of claim 17 further causing a machine to:
calculate the price of an options contract, traded on the futures exchange, based on the futures contract.

21. The article of claim 14 wherein the index value is calculated on at least each trading day of the futures exchange.

22. The article of claim 14 wherein the price of the futures contract is calculated on at least each trading day of the futures exchange.

23. The article of claim 20 wherein the price of the options contract is calculated on at least each trading day of the futures exchange.
